(19) United States
(12) Patent Application Publication
(10) Pub. No.: US 2025/0117860 A1
(43) Pub. Date: Apr. 10, 2025

(54) SERVERS, SYSTEMS, AND METHODS FOR DYNAMIC RISK EVALUATION USING WEIGHTED FACTORS

(71) Applicant: Tam(squared) Inc. d/b/a Paceline, Wellesley, MA (US)

(72) Inventors: Joel Lieginger, Mill Valley, CA (US); David Scott Sharp, New York, NY (US); Bennett Fisher, Wellesley, MA (US); Brandon Vallade, Los Angeles, CA (US); Thomas Gordon Batt, Edenbridge (GB); Vinod Bhadrakshan Paniker, Fremont, CA (US)

(21) Appl. No.: 18/908,515

(22) Filed: Oct. 7, 2024

Related U.S. Application Data
(60) Provisional application No. 63/542,701, filed on Oct. 5, 2023.

(51) Int. Cl. G06Q 40/08; G06Q 30/0601

(52) U.S. Cl. CPC G06Q 40/08; G06Q 30/0641

(57) ABSTRACT

The present disclosure relates to servers, systems, and methods for dynamic risk evaluation using weighted factors. It introduces a decision intelligence-based framework for assessing risk. Traditional methods face challenges like limited data, biases, and static assessments, where the system described herein leverages advanced data analytics, machine learning, and/or predictive modeling to enhance accuracy and personalization. In some embodiments, the system is configured to enable users to enter parameters, targeting criteria, and/or factors for tracking. The system performs risk determination, outputs premiums, and automatically monitors changes in factors over time. In some embodiments, the system enables weightings for factors to be applied automatically, where in some embodiments, AI model are configured to generate the weightings based on predictions. Example factors include heart rate, BMI, and sleep time. In some embodiments, the system is configured to change insurance premiums without human intervention based on changes in life events and/or activity.

### CROSS-REFERENCE TO RELATED APPLICATION

This application claims the priority and benefit of U.S. Provisional Patent Application No. 63/542,701, filed Oct. 5, 2023, which is incorporated by reference herein in its entirety.

### FIELD OF THE DISCLOSURE

The present disclosure is generally related to servers, systems, and methods for determining risk. More particularly, some embodiments of the present disclosure are related to a decision intelligence (DI)-based computerized framework to enable an insurance company, a reinsurance company, or others to assess different types of risk, including, without limitation, the mortality risk of an individual or pool of individuals over the term of a life insurance policy.

### BACKGROUND

Life insurance is a financial instrument designed to provide financial security to beneficiaries upon the death of the policyholder. The primary function of life insurance is to mitigate the economic impact of the policyholder's death by providing a predetermined sum of money (the death benefit) to the beneficiaries. To offer insurance policies that are fair and financially sustainable, insurance companies must accurately assess the mortality risk associated with each policyholder. Mortality risk is the likelihood of the policyholder's death during the term of the insurance policy, and it is a critical factor in determining premiums and policy terms.

The accurate assessment of mortality risk is a fundamental challenge in the life insurance industry, and it involves complex considerations due to the interplay of various factors, including age, gender, health status, lifestyle, occupation, and more. Inaccurate risk assessment can lead to adverse financial consequences for both policyholders and insurance companies. Policyholders may end up paying excessive premiums if their risk is overestimated, while insurance companies may incur losses if they underestimate the risk.

Several problems are associated with the traditional methods of determining mortality risk in life insurance policies:

Limited Data: Historically, insurers relied on limited data sources and statistical tables to assess mortality risk. This approach often oversimplified the risk assessment process and does not consider individual variations in lifestyle, genetics, and health.

Inherent Biases: Traditional methods may be biased against certain demographic groups or individuals with specific health conditions, potentially leading to discrimination in insurance pricing and inappropriate limitations on access to coverage. As just one example, age-based discrimination is common, irrespective of an individual's health conditions, due to the limitations of many actuarial tables.

Static Assessments: Traditional underwriting methods typically result in static assessments made at the time of policy issuance. These assessments do not adapt to changes in the policyholder's health or lifestyle over time.

Uncertainty: Mortality risk is inherently uncertain, making it difficult to accurately predict future outcomes. External factors such as epidemics, natural disasters, or unforeseen medical breakthroughs can significantly impact mortality rates.

Legacy Systems: Many insurance companies rely on outdated underwriting processes and technology, hindering their ability to incorporate new data sources and advanced analytics techniques.

These problems have prevented the development of a system where premium adjustment can be automated without human intervention. Therefore, there is a need for an innovative solution that leverages advanced data analytics, machine learning, and predictive modeling to enhance the accuracy of mortality risk assessment to provide an automated response to a change in risk, such as mortality risk, taking into account individual differences and dynamic changes in health and lifestyle. Furthermore, there is a push for greater transparency and fairness in the underwriting process to ensure that life insurance remains accessible and affordable for a broad spectrum of individuals.

### SUMMARY

In some embodiments, the disclosure is directed to a system comprising one or more computers comprising one or more processors and one or more non-transitory computer readable media, the one or more non-transitory computer readable media including program instructions stored thereon that when executed cause the one or more computers to execute one or more algorithm steps. Some embodiments includes a step to display, by the one or more processors, a graphical user interface (GUI). Some embodiments includes a step to enable, by the one or more processors, a user to enter one or more parameters related to one or more underwriting functions using the GUI. Some embodiments includes a step to enable, by the one or more processors, the user to enter targeting criteria and exclusions using the GUI. Some embodiments includes a step to enable, by the one or more processors, the user to enter one or more factors for the system to track for an insured using the GUI.

Some embodiments includes a step to enable, by the one or more processors, the user to select one or more time periods for factor evaluation for the insured. Some embodiments includes a step to execute, by the one or more processors, a risk determination based on the one or more factors. Some embodiments includes a step to output, by the one or more processors, a premium for the insured based on the risk determination. Some embodiments includes a step to automatically monitor, by the one or more processors, a change in the one or more factors from a first time period to a second time period. Some embodiments includes a step to automatically (without human intervention) change, by the one or more processors, the premium for the insured based on the change in the one or more factors.

In some embodiments, the one or more non-transitory computer readable media include further program instructions stored thereon that when executed cause the one or more computers to execute, by the one or more processors, weightings for each of the one or more factors automatically. Some embodiments includes a step to enable, by the one or more processors, the user to specify the weightings using the GUI. Some embodiments includes a step to execute, by the one or more processors, an automated weighting determination for the one or more factors based on one or more predictions from an artificial intelligence model. In some embodiments, the sum of all weighting must equal 100.

In some embodiments, a heart rate zone factor is assigned a higher weighting than a body mass index factor. In some embodiments, a body mass index factor is assigned a higher weighting than a sleep time factor. In some embodiments, a sleep time factor is assigned a higher weighting than a tracked steps factor. In some embodiments, the change in the one or more factors include a change in a life event of the insured. In some embodiments, the change in the life event includes one or more of a name change, a marital status change, and a family addition. In some embodiments, the change in the life event includes one or more of a department of motor vehicle record change, a financial institution record change, and a reoccurring purchase change. In some embodiments, the change in the life event includes one or more of a change in weekly activity.

In some embodiments, the risk determination includes a mortality risk. In some embodiments, the one or more non-transitory computer readable media include further program instructions stored thereon that when executed cause the one or more computers to automatically add, by the one or more processors, the insured to a risk pool based on the risk determination. In some embodiments, the mortality risk includes a mortality risk of the risk pool.

Other features and functionality of the system in accordance with some embodiments will become apparent based on the detailed description below.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an example configuration workflow according to some embodiments of the present disclosure;

FIG. 4 illustrates an example execution workflow according to some embodiments of the present disclosure;

FIG. 5 depicts an example implementation of an architecture according to some embodiments of the present disclosure;

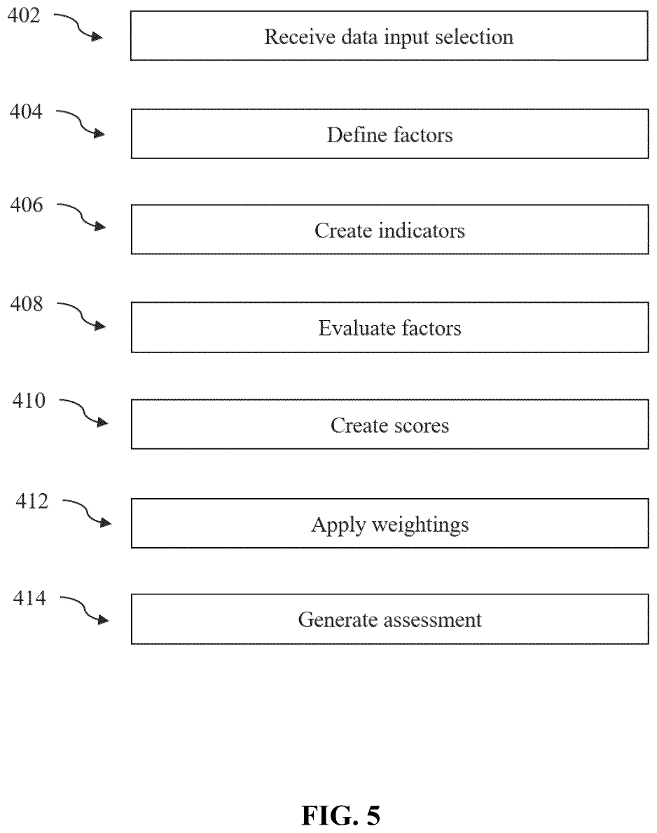

FIG. 6 depicts an example implementation of an architecture according to some embodiments of the present disclosure; and

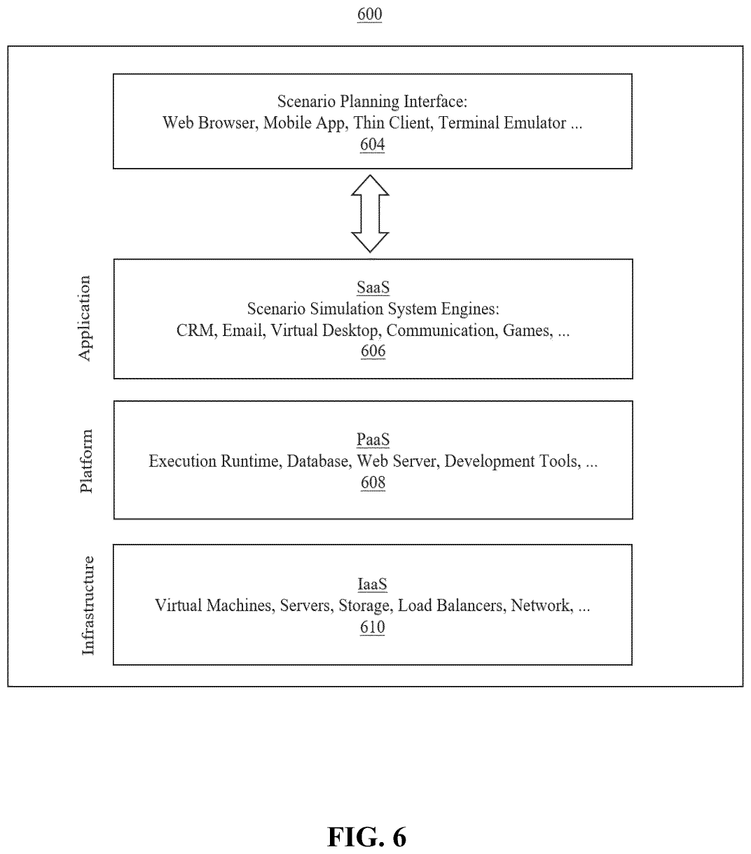

FIG. 7 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain examples according to some embodiments. The present disclosure proposes a novel approach to determine risk. In some non-limiting embodiments, the disclosure provides novel approaches to automatically (without human intervention) determine mortality risk for an individual over the term of a life insurance policy, overcoming some or all of the limitations and challenges associated with traditional methods. By harnessing the power of data and cutting-edge analytical techniques, some embodiments of the invention seek to revolutionize the life insurance industry, offering more accurate risk assessments and improved financial outcomes for both policyholders and insurance providers as well as providing automated risk assessment.

Subject matter may be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in some embodiments” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

As used herein, “can” or “may” or derivations there of (e.g., the system display can show X) are used for descriptive purposes only and is understood to be synonymous and/or interchangeable with “configured to” (e.g., the computer is configured to execute instructions X) when defining the metes and bounds of the system. The phrase “configured to” also denotes the step of configuring a structure or computer to execute a function according to some embodiments.

The present disclosure is described below with reference to block diagrams and operational illustrations of methods and devices according to some embodiments. It is understood that each block of the block diagrams or operational illustrations, and combinations of blocks in the block diagrams or operational illustrations, can be implemented by means of analog or digital hardware and computer program instructions. In some embodiments, these computer program instructions can be provided to a processor of a general-purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some embodiments, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved according to some embodiments.

For the purposes of this disclosure, in some embodiments, a non-transitory computer readable medium (or computer-readable storage medium/media) stores computer data, which can include computer program code (or computer-executable instructions) that is executable by a computer, in machine readable form. By way of example, and not limitation, in some embodiments, a computer readable medium may include computer readable storage media, for tangible or fixed storage of data, or communication media for transient interpretation of code-containing signals. In some embodiments, computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. In some embodiments, computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities according to some embodiments. By way of example, and not limitation, in some embodiments, the term “server” can refer to a single, physical processor with associated communications and data storage and database facilities, or it can refer to a networked or clustered complex of processors and associated network and storage devices, as well as operating software and one or more database systems and application software that support the services provided by the server: cloud servers are examples.

In some embodiments, for the purposes of this disclosure, a “network” should be understood to refer to a network that may couple devices so that communications may be exchanged, such as between a server and a client device or other types of devices, including between wireless devices coupled via a wireless network, for example. In some embodiments, a network may also include mass storage, such as network attached storage (NAS), a storage area network (SAN), a content delivery network (CDN) or other forms of computer or machine-readable media, for example. In some embodiments, a network may include the Internet, one or more local area networks (LANs), one or more wide area networks (WANs), wire-line type connections, wireless type connections, cellular or any combination thereof. In some embodiments, sub-networks, which may employ differing architectures or may be compliant or compatible with differing protocols, may interoperate within a larger network.

For purposes of this disclosure, in some embodiments, a “wireless network” should be understood to couple client devices with a network. In some embodiments, a wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4th or 5th generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In some embodiments, a wireless network may include virtually any type of wireless communication mechanism by which signals may be communicated between devices, such as a client device or a computing device, between or within a network, or the like.

In some embodiments, a computing device, which may include one or more computers, may be capable of sending or receiving signals, such as via a wired or wireless network, or may be capable of processing or storing signals, such as in memory as physical memory states, and may, therefore, operate as a server. Thus, in some embodiments, devices capable of operating as a server may include, as examples, dedicated rack-mounted servers, desktop computers, laptop computers, set top boxes, integrated devices combining various features, such as two or more features of the foregoing devices, or the like.

In some embodiments, for purposes of this disclosure, a client (or user, entity, subscriber or customer) device may include a computing device capable of sending or receiving signals, such as via a wired or a wireless network. In some embodiments, a client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer,, an integrated or distributed device combining various features, such as features of the forgoing devices, or the like.

In some embodiments, a client device may vary in terms of capabilities or features. In some embodiments, claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

Some embodiments and principles will be discussed in more detail with reference to the figures. According to some embodiments, the disclosed framework provides integrated control and management of one or more devices and/or the applications executing thereon.

By way of a non-limiting example, according to some embodiments, the system includes a decision engine configured to use any set of factors, along with appropriate weightings, in evaluating the risk associated with an individual and/or how that risk changes over time.

According to some embodiments, the discussion herein may focus on some embodiments related to determine mortality risk for an individual over the term of a life insurance policy. However, these examples should not be construed as limiting, as one of skill in the art would understand that the disclosed framework described herein can determine risk in a variety of applications without departing from the scope of the instant disclosure.

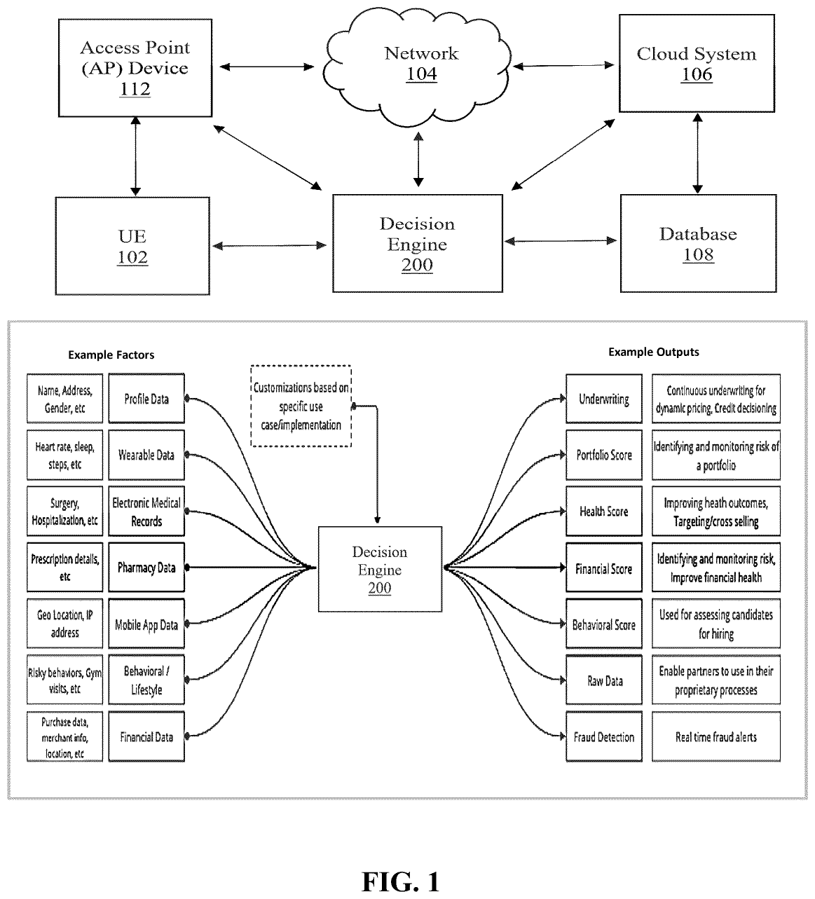

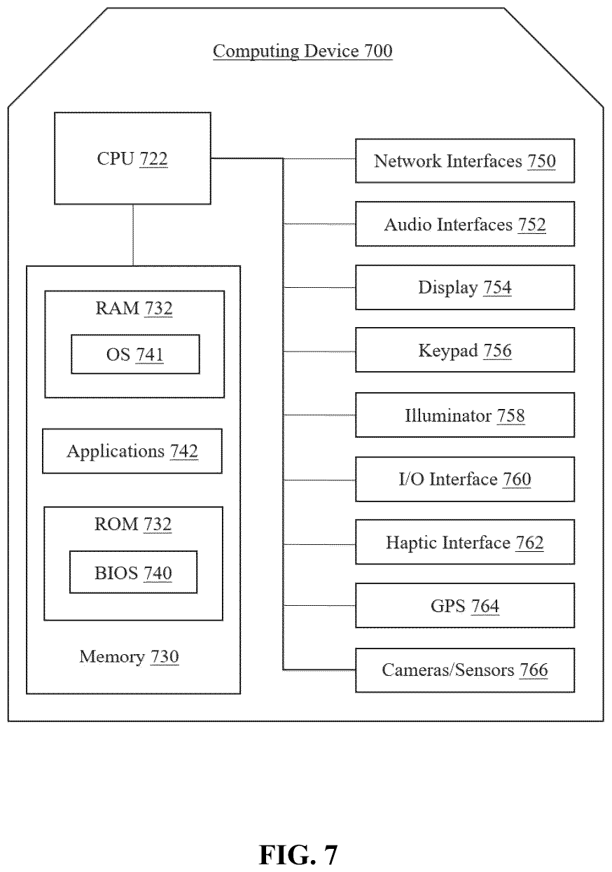

With reference to FIG. 1, in some embodiments system 100 is depicted which includes user equipment (UE) 102 (e.g., a client device, as mentioned above and discussed below in relation to FIG. 7), access point (AP) device 112, network 104, cloud system 106, database 108 and decision engine 200. It should be understood that while system 100 is depicted as including such components, it should not be construed as limiting, as one of ordinary skill in the art would readily understand that varying numbers of UEs, AP devices, peripheral devices, cloud systems, databases and networks can be utilized; however, for purposes of explanation, system 100 is discussed in relation to the example depiction in FIG. 1 in some embodiments.

According to some embodiments, UE 102 can be any type of device, such as, but not limited to, a mobile (smart) phone, tablet, laptop, sensor, IoT device, autonomous machine, appliance, and/or any other device equipped with a cellular and/or wireless or wired transceiver. For example, in some embodiments, UE 102 can be a smart phone with various Apps installed, which as discussed below in more detail, can enable the identification and/or collection of activity information of the user to guide actual App and/or UE usage.

In some embodiments, one or more peripheral devices (not shown) can be connected to UE 102, and can be any type of peripheral device, such as, but not limited to, a wearable device (e.g., smart watch), and/or one or more sensors. In some embodiments, peripheral device can be any type of device that is connectable to UE 102 via any type of known or to be known pairing mechanism, including, but not limited to, WiFi, Bluetooth™, Bluetooth Low Energy (BLE), NFC, and the like. For example, the peripheral device can be a driving monitoring device that connectively pairs with UE 102, which is a user's smart phone in some non-limiting examples according to some embodiments.

In some embodiments, the system includes one or more sensors capable of monitoring specific behaviors and environmental factors. These sensors may include accelerometers and gyroscopes to detect movement, speed, and orientation, enabling monitoring of activities such as driving habits, physical exercise, and potential falls. In some embodiments, heart rate monitors and electrocardiogram (ECG) sensors are included to track cardiovascular health, while blood pressure sensors can provide additional data on physical well-being. In some embodiments, the system includes respiratory sensors configured to detect breathing patterns to assess general health or fitness during activities. In some embodiments, skin temperature sensors evaluate stress levels, and in some embodiments, galvanic skin response (GSR) sensors detect emotional arousal or anxiety.

For tracking external environmental factors, in some embodiments, GPS sensors are used to log location and travel routes, allowing risk assessments for driving habits or frequenting hazardous locations. In some embodiments, the system includes acoustic sensors configured to capture sound data to monitor environmental noise levels, assessing the user's exposure to loud environments that could affect health.

In some embodiments, for sleep quality monitoring, the system includes an actigraphy sensor, which, coupled with motion and heart rate sensors, in some embodiments, track sleep patterns, detecting disturbances or irregular sleep that could indicate a health risk. In some embodiments, the system includes ambient light sensors and air quality sensors configured to monitor exposure to proper lighting and air conditions, contributing to risk evaluation in areas such as long-term health or well-being. In some embodiments, the system is configured to accept an input from any sensor listed here, and/or any type of sensor capable of monitoring the example factors listed in FIG. 1, inter alia.

According to some embodiments, AP device 112 is a device that creates a wireless local area network (WLAN) for the location. According to some embodiments, the AP device 112 can be, but is not limited to, a router, switch, hub and/or any other type of network hardware that can project a WiFi signal to a designated area. In some embodiments, UE 102 may include an AP device.

In some embodiments, network 104 can be any type of network, such as, but not limited to, a wireless network, cellular network, the Internet, and the like (as discussed above). In some embodiments, network 104 facilitates connectivity of the components of system 100, as illustrated in FIG. 1.

According to some embodiments, cloud system 106 may be any type of cloud operating platform and/or network-based system upon which applications, operations, and/or other forms of network resources may be located. For example, system 106 may be a service provider and/or network provider from where services and/or applications may be accessed, sourced or executed from. For example, in some embodiments, system 106 can represent the cloud-based architecture associated with a smart home or network provider, which has associated network resources hosted on the internet or private network (e.g., network 104), which enables (via engine 200) collection of the factors discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE 102, AP device 112, and the services and applications provided by cloud system 106 and/or decision engine 200).

In some embodiments, for example, cloud system 106 can provide a private/proprietary management platform, whereby decision engine 200, discussed infra, corresponds to the novel functionality system 106 enables, hosts and provides to a network 104 and other devices/platforms operating thereon.

Turning back to FIG. 1, according to some embodiments, database 108 may correspond to a data storage for a platform (e.g., a network hosted platform, such as cloud system 106, as discussed supra) or a plurality of platforms. In some embodiments, database 108 may receive storage instructions/requests from, for example, decision engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

In some embodiments, decision engine 200, as discussed above and further below in more detail, can include components for the disclosed functionality. According to some embodiments, decision engine 200 may be a special purpose machine or processor and can be hosted by a device on network 104, within cloud system 106, on AP device 112 and/or on UE 102. In some embodiments, decision engine 200 may be hosted by a server and/or set of servers associated with cloud system 106.

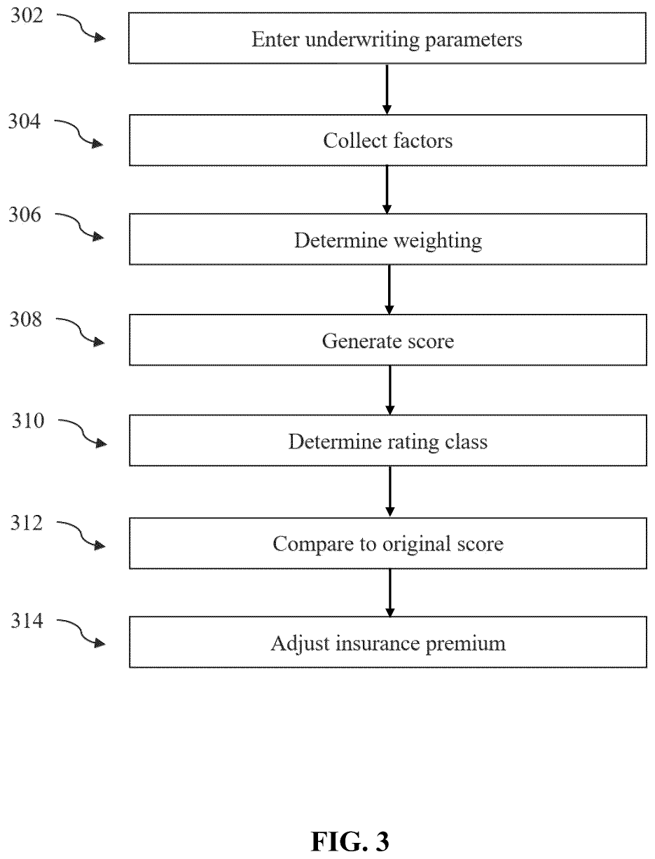

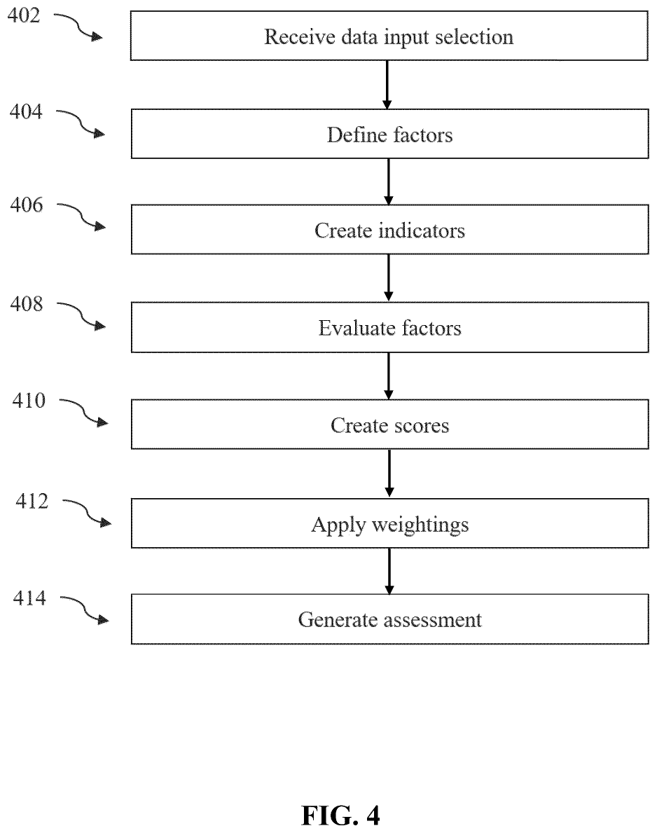

According to some embodiments, as discussed in more detail below, decision engine 200 may be configured to implement and/or control a plurality of services and/or microservices, where each of the plurality of services/microservices are configured to execute a plurality of workflows associated with performing the disclosed evaluation framework. Non-limiting embodiments of such workflows are provided below in relation to at least FIGS. 3-4.

According to some embodiments, as discussed above, decision engine 200 may function as an application provided by cloud system 106. In some embodiments, decision engine 200 may function as an application installed on a server(s), network location and/or other type of network resource associated with system 106. In some embodiments, decision engine 200 may function as application installed and/or executing on UE 102 (and/or AP device 112, in some embodiments). In some embodiments, such application may be a web-based application accessed by AP device 112 and/or UE over network 104 from cloud system 106. In some embodiments, decision engine 200 may be configured and/or installed as an augmenting script, program or application (e.g., a plug-in or extension) to another application or program provided by cloud system 106 and/or executing on AP device 112 and/or UE 102.

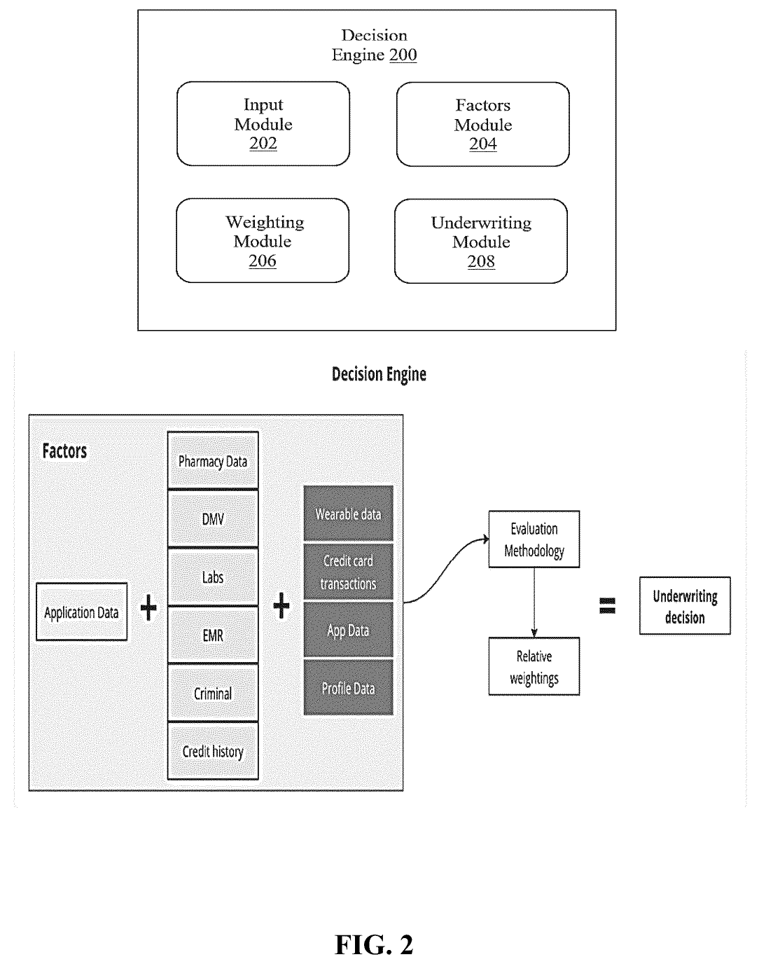

As illustrated in FIG. 2, according to some embodiments, decision engine 200 includes an input module 202, a factors module 204, a weighting module 206, and an underwriting module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of decision engine 200 and each of its modules, and their role within embodiments of the present disclosure will be discussed below.

As a non-limiting example, in some embodiments, the system is configured to enable an insurance company to provide a life insurance product that has a variable premium within a specified percentage range to be adjusted periodically by an assessment of the insured's mortality risk at the time of the premium adjustment. In some embodiments, a life insurance product may be issued with a monthly premium of $Y, to be adjusted annually to no more than $Y ±15%, on the basis of a current assessment of the insured's mortality risk. In some embodiments, the system is configured by the life insurance company to monitor the activity and behavioral information of each policyholder, thus providing the information necessary to increase or decrease the premium within the specified limits of the policy. In some embodiments, these adjustments are made on a periodic (such as quarterly or annual) basis. In some jurisdictions, regulations require that the periodic assessments that drive the premium adjustments use the same factors and weightings as those used to issue the policy.

Turning to FIG. 3, Process 300 provides non-limiting example embodiments for the disclosed system. According to some embodiments, Process 300 provides non-limiting embodiments for risk assessment for which the disclosed framework (e.g., via decision engine 200) can control, manage and manipulate an individual's insurance premium (e.g., monthly, yearly). Steps described in the figures represent both an execution of a computer algorithm and a method of implementing the system according to some embodiments.

According to some embodiments, Steps 302 of Process 300 can be performed by input module 202 of decision engine 200; Step 304 can be performed by factors module 204; Step 306-312 can be performed by weighting module 206; and Step 314 can be performed by determination underwriting module 208.

In some embodiments, an insurance company licenses the system in order to perform frequent or continuous underwriting and support dynamic pricing. In some embodiments, the system is configured to offer an insurance product, onboard users, apply custom underwriting criteria, and/or bind the policy to the user.

According to some embodiments, Process 300 begins with Step 302 where an insurance company uses a GUI to enter the parameters governing the operation of the continuous underwriting functions within the system. In some embodiments, these parameters may include frequency, assessment type (continuous underwriting or risk monitoring), and prompted instructions when insufficient data is available. In some embodiments, the insurance company uses the GUI to enter targeting criteria (such as certain life event triggers like recent marriage or family additions, income range, among others) and exclusions (such as residents in states where the company or policy is not registered, age restrictions, among others), details about the policy to be offered and other details about the targeting campaign.

In some embodiments, when entering target criteria via a GUI, the system is configured to enable a user to choose from a list of life events that are tracked by the system either through direct (such as a name change or marital status change reflected on records from the DMV or a financial institution, among others) or indirect signals, some of which may be driven by a ML/AI model which associates certain indirect indicators with likely life events (such as certain recurring purchases which may indicate a recent birth in the family, among others). The data can be obtained through one or more sensors and/or one or more databases. In some embodiments, the GUI is configured to enable a user to enter the components of the underwriting assessment, including the identification of factors, evaluation methodology, and relative weightings compared to other factors.

In some embodiments, when entering underwriting assessment factors via a GUI, the user may choose from a list of available factors, define the evaluation time period, or use a formula builder to combine one or more factors using arithmetic or logical operations (such as defining a new factor “activity delta” defined as the average change in weekly activity minutes divided by the number of weeks for which activity data is available, among others).

In some embodiments, in Step 304, the system is configured to collect the factors defined by the company automatically in order to perform an underwriting assessment using the weightings and evaluation methodology defined by the company as further described below. In some embodiments, in Step 308, the decision engine 200 is configured to automatically output an underwriting assessment score and, in some embodiments, a rating class determination at Step 310 based on the criteria entered by the company and the applicant's and/or insured's currently available factors.

In Step 312, decision engine 200 automatically generates the underwriting assessment score and/or the rating class determination are compared to the prior values calculated either at the time of policy issuance or the previous cycle of underwriting review. According to some embodiments, the analysis can involve any type of computational analysis that can enable engine 200 to derive, determine, extract, retrieve or otherwise generate the score and/or determination. In some embodiments, the computational analysis includes statistical analysis that includes one or more of linear regression, logistic regression, generalized linear models (GLM), and survival analysis. In some embodiments, the system uses linear regression for continuous data, such as predicting the cost of a claim based on age and driving history, as non-limiting examples. In some embodiments, the system is configured to use logistic regression for binary outcomes (e.g., claim or no claim), where the logistic regression is configured to calculate the probability that a claim will occur based on a set of variables. In some embodiments, GLM is used by the system to handle non-normal data, such as claim frequency and severity, as non-limiting examples. In some embodiments, the system is configured to use survival analysis to estimate the time until an event (e.g., claim or incident) happens. In some embodiments, the system passes the latest underwriting assessment score, the change in the underwriting assessment, the rating class determination, the change in rating class determination, and/or the latest raw factors via an API to the insurance company.

In some embodiments, at Step 314, the change in the underwriting assessment and/or rating class is used to automatically (without human intervention) increase or decrease the insured's premium for the next period, such that the new insurance premium presented to an insured, for example by GUI, email, text, printed bill, and/or any other system output, is different than the original premium. In some embodiments, the system automatically saves all of the information so it will be available the next time that the underwriting assessment is recalculated.

In some embodiments, engine 200 may include a trained artificial intelligence (AI), including a machine learning model (AI/ML), a machine learning model architecture, a machine learning model type (e.g., convolutional neural network (CNN), recurrent neural network (RNN), autoencoder, support vector machine (SVM), and the like), or any other suitable definition of a machine learning model or any suitable combination thereof. In some embodiments, one or more AI models are configured to assign the weights based on one or more AI predictions.

In some embodiments, decision engine 200 may be configured to utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like. By way of a non-limiting example, decision engine 200 can implement an XGBoost algorithm for regression and/or classification to analyze the sensor data, as discussed herein.

According to some embodiments, the AI/ML computational analysis algorithms implemented can be applied and/or executed in a time-based manner, in that collected sensor data for specific time periods can be allocated to such time periods to determine an individual's habits and lifestyle. For example, in some embodiments, decision engine 200 can execute a Bayesian determination for a predetermined time span, at preset intervals (e.g., a 24 hour time span, every 8 hours, based on learned/understood habits (e.g., sleeping, driving, working out, and the like, as non-limiting examples), so as to segment the day according to patterned routines, which can be leveraged to determine, derive, extract or otherwise weight one or more factors.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
define Neural Network architecture/model for the control framework,
transfer the input data to the neural network model,
train the model incrementally,
determine the accuracy for a specific number of timesteps,
apply the trained model to process the newly received input data,
optionally and in parallel, continue to train the trained model with a predetermined periodicity.

In some embodiments and, optionally, in combination of any embodiment described above or below, the trained AI model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained AI model may also be specified to include other parameters, including but not limited to, bias values/functions and/or aggregation functions. For example, in some embodiments, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

As described above, in some embodiments the system is configured to use a combination of factors and weighting to determine an underwriting decision, rating class decision and/or insurance premium according to calculated risk. In some embodiments, various factors may be established using information from one or more data sources, with the information from the data source directly defining the factor, or the factor may be derived based on one or more of these inputs. In some embodiments, these factors may also represent a measurement at one point in time or be the result of measurements taken over a period of time (hours, days, weeks, months, or years). Any set of factors, along with appropriate weightings, can be used to drive the decision engine in evaluating the risk associated with an individual according to some embodiments.

In some embodiments, some or all of the information used to establish the factors may be obtained automatically from multiple sources, including data entered by the individual, data received from a wearable device, from a mobile device (such as a phone or tablet, among others), from a data clearinghouse (such as doctor visit history, prescription history, driving history, electronic medical records, arrest records, among others), from financial institutions (such as credit card records, banking records, mortgage records, insurance policy records, among others), from social networks, from one or more mobile applications, from observed behavioral or lifestyle activities (such as gym visits, sports activities, risky activities, purchases, among others), from educational institutions, social networks including accounts of friends and/or relatives, and from other organizations.

In some embodiments, established factors include demographic factors (such as address, gender identification, gender at birth, education level, profession, marital status, number of children, affiliations, among others). Some embodiments include wearable data factors (such as heart rate, resting heart rate, amount of time in each sleep zone, amount of time at each activity level, activities pursued, heart rate variability, calories burned, steps, walking or running distance, running speed, heart rate recovery, cardiorespiratory fitness, glucose levels, among others). Some embodiments include factors based on information from a mobile device (such as location, IP address, device type and software version, among others). Some embodiments include factors from electronic medical records (such as blood pressure, body temperature, height, weight, respiratory rate, pulse, hereditary conditions, tobacco use, among others). In some embodiments, the system uses factors from medication history (prescriptions and fill/refill patterns, immunizations/vaccinations, factors from doctor visit history (such as diagnoses, chronic conditions, surgeries, lab results, among others). In some embodiments, the system is configured to use factors from DMV or criminal records (such as DUI convictions, driving violations, felony convictions, among others). Some embodiments include factors from financial information (such as transactions, balances, income, payment history, merchants patronized, defaults, bankruptcies, mortgage information, type and amount of insurance policies, among others). In some embodiments, inputs from social media accounts (such as social activities, hobbies, among others) are used as factors in determining risk. In some embodiments, factors are automatically derived from behavioral or lifestyle observations (such as duration and frequency of gym visits, participation in risky activities like scuba or sky diving, activity type and frequency, purchase and merchant patterns, among others). Some embodiments include factors based on education data (such as higher education participation, degrees earned, and schools attended, among others). Factors can be automatically established based on information from a single source or a combination of information from multiple sources according to some embodiments.

As a non-limiting example, some embodiments may use one or more factors, combined with a set of weightings, to allow the decision engine to automatically reach the desired conclusion. As a non-limiting example, the system is configured to enable an insurance company to automatically assess the mortality risk of an individual over the term of a life insurance policy. In some embodiments, the system is configured to enable the life insurance company to specify the factors and the weightings that guides the risk calculation. In some embodiments, these factors include a time series of activity or medical observations that provide insight into the activity patterns of the individual over a period of time rather than at a single point in time. In some embodiments, these factors are used to automatically generate an underwriting decision (should the individual be approved or declined for the policy) and/or a rating class decision, which is used to establish the policy's price.

In some embodiments, the system is configured to enable automatic periodic risk assessments of a pool of policyholders to allow the insurance company to adjust reserves in accordance with the current mortality risk of the pool members. In some embodiments, this assessment is determined using a set of factors and weightings that may differ substantially from those used to make the underwriting decision at the time of policy issuance. In some embodiments, this allows the insurance company to substantiate the improved or worsened risk of a pool of policies using the latest understanding of the factors and weightings that drive mortality risk individually.

Turning to FIG. 4, Process 400 provides non-limiting example embodiments for the deployment and/or implementation of the disclosed herein. As a non-limiting example, an insurance company may use the system to automatically create an underwriting assessment based on one or more of four criteria: average time spent each week in each heart rate zone, average amount of daily sleep, average daily steps, and body mass index (BMI). In some embodiments, to configure the system to perform the assessment there are 3 steps to perform: factor identification, evaluation methodology, and relative weightings.

According to some embodiments, Step 402 of Process 400 can be performed by factors module 204 of decision engine 200, and Steps 404-414 can be performed by weighting module 206.

According to some embodiments, Process 400 begins with Step 402 where decision engine 200 receives a selection of the data inputs, time period and type of accumulation. In some embodiments, for time spent in each heart rate zone, the system is configured to automatically calculate the heart rate zones for each individual based on their age, gender, and/or maximum heart rate. In some embodiments, the system is configured to automatically read the collection of heart rate readings to calculate time spent at each heart rate and translate it into heart rate zones. In some embodiments, at Step 404 the system is configured to enable the user to indicate that the factor should equal the sum of time in each zone. In some embodiments, the time period is weekly, and the accumulation type is average as a non-limiting example. In some embodiments, at Step 406, the system is configured to automatically create a set of indicators for the individual which represent the average amount of time spent in each heart rate zone each week. In some embodiments, for sleep time, the data input is time asleep, the time period is daily, and the accumulation type is average. In some embodiments, for steps, the data input is step count, the time period is daily, and the accumulation type is average. In some embodiments, for BMI the data inputs are height and weight, the time period is latest, and the accumulation type is formula with the formula specified as weight (kg) divided by height (meters) squared.

In some embodiments, the system is configured to automatically evaluate one or more factors at Step 408 and convert the factors into one or more scorable numbers at step 410. As non-limiting examples according to some embodiments, Heart Rate Zones are automatically evaluated by assigning 1 to any individual with no moderate or intense activity minutes; a score of 2 is automatically assigned to any individual with 0 to 100 moderate activity minutes per week and no intense activity minutes; a score of 3 is automatically assigned to any individual with more than 100 to 200 minutes per week of moderate activity with no intense activity minutes; a score of 4 is automatically assigned to any individual with more than 200 moderate activity minutes per week and no intense activity minutes. In some embodiments, the individual's heart rate zone score is automatically increased by 1 if the individual has 1 to 50 intense activity minutes per week; the individual's heart rate zone score is automatically increased by 2 if the individual has more than 50 to 100 minutes per week of intense activity; and/or the individual's heart rate zone score is automatically increased by 3 if the individual has more than 100 minutes per week of intense activity. In some embodiments, an individual's heart rate zone score is automatically decreased if the individual exceeds heart rates in excess of what is commonly deemed safe for the individual's age.

In some embodiments, sleep time is automatically evaluated by assigning a score of 1 for up to 4 hours of sleep per day; a score of 2 for more than 4 and up to 5 hours of sleep per day; a score of 3 for more than 5 and up to 6 hours of sleep per day; a score of 4 for more than 6 and up to 7 hours of sleep per day; a score of 5 for more than 7 and up to 8 hours of sleep per day; a score of 6 for more than 8 and up to 9 hours of sleep per day; and a score of 7 for more than 9 hours of sleep per day.

In some embodiments, daily steps are evaluated by automatically assigning a score of 1 if average steps per day are less than 8,000; a score of 2 if steps are more than 7,999 and up to 10,000 per day; a score of 3 if steps are more than 10,000 and up to 12,000 per day; a score of 3 if steps are more than 12,000 and up to 14,000 per day; a score of 4 if steps are more than 14,000 and up to 16,000 per day; a score of 5 if steps are more than 16,000 and up to 18,000 per day; and a score of 7 if steps are more than 20,000 per day.

In some embodiments, BMI is automatically evaluated by assigning a score of 0 if BMI is over 35; a score of 1 if BMI is more than 33 and up to 35; a score of 2 if BMI is more than 30 and up to 33; a score of 3 if BMI is more than 28 and up to 30; a score of 4 if BMI is more than 26 and up to 28; a score of 5 if BMI is more than 24 and up to 26; a score of 6 if BMI is more than 21 and up to 24; and a score of 7 if BMI is 21 or less, as non-limiting examples.

At Step 412, the system is configured to automatically apply weighting to the factors according to some embodiments. In some embodiments, relative weightings drive the calculation of the assessment by specifying the relative weight given to each of the evaluated criteria. In some embodiments, the sum of all weightings must equal 100. As non-limiting examples according to some embodiments, heart rate zone is automatically assigned a weighting of 40; sleep time weighting is assigned a value of 20; steps is assigned a weighting of 10; and BMI weighting is assigned a value of 30. In some embodiments, the overall assessment is automatically calculated by summing each evaluated factor score times its weighting. In some embodiments, at Step 414, the weighting module 206 is configured to generate the risk assessment which may be used by underwriting module 208 to provide a modified premium or a desired scoring output.

In some embodiments, the system is configured to automatically identify appropriate users that meet the targeting criteria and for which sufficient health and financial data exists to support an underwriting assessment. In some embodiments, the system is configured to automatically present the identified user with an offer to determine interest in the insurance product. In some embodiments, the offer is presented via email, text message, in-app notification, banner within the app or as a tile on one or more views within an App. In some embodiments, the offer is automatically presented through targeted messaging within a social app or search engine.

In some embodiments, users may express interest in the offer by engaging with the offer communication by taking action according to the terms and instructions within the offer. In some embodiments, users then receive a quote for the insurance product, which may include answering a few questions necessary to configure the product according to the user's needs (such as term of coverage, and coverage amount, among others) and supplying or verifying any demographic information needed to estimate the cost of the insurance (such as age, gender, among others). After receiving the quote, the user can choose to exit or to begin the onboarding process according to some embodiments. In some embodiments, the user may immediately elect to start the onboarding process.

In some embodiments, the user begins the onboarding process, which includes the entry or verification of certain demographic and identification information. In some embodiments, the system performs a number of verifications, including, but not limited to, Know-Your-Customer analyses, a DMV record check, and a OFAC check, among others.

In some embodiments, as described above, the system collects the factors defined by the company in order to perform an automatic underwriting assessment using the weightings and evaluation methodology configured for this embodiment by the insurance company. In some embodiments, the output of this process is an underwriting assessment score, and, in some embodiments, a rating class determination based on the criteria entered by the company. In some embodiments, the system passes the underwriting assessment score, the rating class determination, and/or the raw factors via an API to the insurance company.

In some embodiments, the insurance company confirms the automatic underwriting assessment, rating class determination, and returns confirmation of the underwriting decision, policy premiums pricing and any other information relevant to the user as they consider a purchase decision. In some embodiments, the system is configured to show the approval or decline decision via a GUI. If approved, the user is also presented via the same GUI, the policy pricing, and/or any other pertinent information to assist with the purchase decision according to some embodiments.

In some embodiments, if the user decides to purchase the policy, the system is configured to obtain details needed to complete the purchase (such as an electronic signature confirming the purchase, payment details, among others). In some embodiments, this information is passed to the insurance company so they may process the first premium payment and bind the policy, issuing the policy number. In some embodiments, the system retrieves the policy number and policy documents which are then displayed to the user via the GUI.

In some embodiments, after policy issuance, the system uses the methods described earlier in this document to automatically encourage the user to maintain and/or improve their health, thus reducing the risk for the individual below the expected mortality risk at the time the policy was issued. In some embodiments, the system uses the underwriting assessment factors and evaluation methodology to automatically continuously monitor and re-assess changes in the assessment over time. In some embodiments, the system is configured to report any changes (e.g., positive, negative) to the insurance company.

FIG. 7 is a schematic diagram illustrating a client device showing an example embodiment of a client device that may be used within the present disclosure and/or the framework illustrated in FIG. 1. Client device 700 may include many more or fewer components than those shown in FIG. 7, such as a plurality of one or more computers. However, the components shown are sufficient to disclose an illustrative embodiment for implementing the present disclosure. Client device 700 may represent, for example, UE 102 discussed above at least in relation to FIG. 1.

As shown in the figure, in some embodiments, client device 700 includes one or more processors (CPU) 722 in communication with one or more non-transitory computer readable media 730 via a bus 724. Client device 700 also includes a power supply 726, one or more network interfaces 750, an audio interface 752, a display 754, a keypad 756, an illuminator 758, an input/output interface 760, a haptic interface 762, an optional global positioning systems (GPS) receiver 764 and a camera(s) or other optical, thermal or electromagnetic sensors 766. Device 700 can include one camera/sensor 766, or a plurality of cameras/sensors 766, as understood by those of skill in the art. Power supply 726 provides power to Client device 700.

Client device 700 may optionally communicate with a base station (not shown), or directly with another computing device. In some embodiments, network interface 750 is sometimes known as a transceiver, transceiving device, or network interface card (NIC).

Audio interface 752 is arranged to produce and receive audio signals such as the sound of a human voice in some embodiments. Display 754 may be a liquid crystal display (LCD), gas plasma, light emitting diode (LED), or any other type of display used with a computing device. Display 754 may also include a touch sensitive screen arranged to receive input from an object such as a stylus or a digit from a human hand.

Keypad 756 may include any input device arranged to receive input from a user. Illuminator 758 may provide a status indication and/or provide light.

Client device 700 also includes input/output interface 760 for communicating with external. Input/output interface 760 can utilize one or more communication technologies, such as USB, infrared, Bluetooth™, or the like in some embodiments. Haptic interface 762 is arranged to provide tactile feedback to a user of the client device.

Optional GPS transceiver 764 can determine the physical coordinates of Client device 700 on the surface of the Earth, which typically outputs a location as latitude and longitude values. GPS transceiver 764 can also employ other geo-positioning mechanisms, including, but not limited to, triangulation, assisted GPS (AGPS), E-OTD, CI, SAI, ETA, BSS or the like, to further determine the physical location of client device 700 on the surface of the Earth. In one embodiment, however, Client device may through other components, provide other information that may be employed to determine a physical location of the device, including for example, a MAC address, Internet Protocol (IP) address, or the like.

Mass memory 730 includes a RAM 732, a ROM 734, and other storage means. Mass memory 730 illustrates another example of computer storage media for storage of information such as computer readable instructions, data structures, program modules, usage data, or other data. Mass memory 730 stores a basic input/output system (“BIOS”) 740 for controlling low-level operation of Client device 700. The mass memory also stores an operating system 741 for controlling the operation of Client device 700.

Memory 730 further includes one or more data stores, which can be utilized by Client device 700 to store, among other things, applications 742 and/or other information or data. For example, data stores may be employed to store information that describes various capabilities of Client device 700. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 700.

Applications 742 may include computer executable instructions which, when executed by Client device 700, transmit, receive, and/or otherwise process audio, video, images, and enable telecommunication with a server and/or another user of another client device. Applications 742 may further include a client that is configured to send, to receive, and/or to otherwise process gaming, goods/services and/or other forms of data, messages and content hosted and provided by the platform associated with engine 200 and its affiliates.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

We claim:

1. A system comprising:
one or more computers comprising one or more processors and one or more non-transitory computer readable media, the one or more non-transitory computer readable media including program instructions stored thereon that when executed cause the one or more computers to:
display, by the one or more processors, a graphical user interface (GUI);
enable, by the one or more processors, a user to enter one or more parameters related to one or more underwriting functions using the GUI;
enable, by the one or more processors, the user to enter targeting criteria and exclusions using the GUI;
enable, by the one or more processors, the user to enter one or more factors for the system to track for an insured using the GUI;
enable, by the one or more processors, the user to select one or more time periods for factor evaluation for the insured;
execute, by the one or more processors, a risk determination based on the one or more factors;
output, by the one or more processors, a premium for the insured based on the risk determination;
monitor, by the one or more processors, a change in the one or more factors from a first time period to a second time period; and
change, by the one or more processors, the premium for the insured based on the change in the one or more factors.

2. The system of claim 1,
wherein the one or more non-transitory computer readable media include further program instructions stored thereon that when executed cause the one or more computers to:
execute, by the one or more processors, weightings for each of the one or more factors.

3. The system of claim 2,
wherein the one or more non-transitory computer readable media include further program instructions stored thereon that when executed cause the one or more computers to:
enable, by the one or more processors, the user to specify the weightings using the GUI.

4. The system of claim 2,
wherein the one or more non-transitory computer readable media include further program instructions stored thereon that when executed cause the one or more computers to:
execute, by the one or more processors, a weighting determination for the one or more factors based on one or more predictions from an artificial intelligence model.

5. The system of claim 2,
wherein the sum of all weighting must equal 100.

6. The system of claim 5,
wherein a heart rate zone factor is assigned a higher weighting than a body mass index factor.

7. The system of claim 6,
wherein a body mass index factor is assigned a higher weighting than a sleep time factor.

8. The system of claim 7,
wherein a sleep time factor is assigned a higher weighting than a tracked steps factor.

9. The system of claim 1,
wherein the change in the one or more factors include a change in a life event of the insured.

10. The system of claim 9,
wherein the change in the life event includes one or more of a name change, a marital status change, and a family addition.

11. The system of claim 9,
wherein the change in the life event includes one or more of a department of motor vehicle record change, a financial institution record change, and a reoccurring purchase change.

12. The system of claim 9,
wherein the change in the life event includes one or more of a change in weekly activity.

13. The system of claim 1,
wherein the risk determination includes a mortality risk.

14. The system of claim 9,
wherein the one or more non-transitory computer readable media include further program instructions stored thereon that when executed cause the one or more computers to:
add, by the one or more processors, the insured to a risk pool based on the risk determination.

15. The system of claim 10,
wherein the mortality risk includes a mortality risk of the risk pool.
